(19) United States
(12) Patent Application Publication
(10) Pub. No.: US 2011/0197872 A1
(43) Pub. Date: Aug. 18, 2011

(54) Portable heating device

(76) Inventor: Philippe Thiry, Longueuil (CA)

(21) Appl. No.: 12/931,796

(22) Filed: Feb. 9, 2011

(30) Foreign Application Priority Data
Feb. 16, 2010 (CA) 2,693,236

(51) Int. Cl. A47J 37/07

(52) U.S. Cl. 126/25 R

(57) ABSTRACT

A barbecue kit comprising a bowl having a base and side walls, the base having a central planar portion and a plurality of downwardly sloping portions between the planar central portion and the walls, a plurality of apertures in the base, a support assembly including a manifold connected to a plurality of hollow support arms and a fan associated with the manifold to blow air through the hollow support arms to the interior of the bowl.

### FIELD OF THE INVENTION

The present invention relates to a portable heating device and more particularly, relates to a portable heating device which may be used for cooking.

### BACKGROUND OF THE INVENTION

There are many different types of portable devices which may be used for one or both of heating and cooking purposes. Thus, there exist the so-called outdoor fireplaces which may be used on flammable surfaces such as wood and the like. Generally, their design is geared to providing a aesthetically pleasing fire which may also be used for heating purposes.

A somewhat different device is a barbecue. The use for barbecues to cook food is well established in the art. Many types of barbecues exist, including, for example, gas barbecues, charcoal and briquette barbecues, smokers, etc.

Certain people demand a barbecue which is highly portable and utilizes little space when stored. This type of barbecue is required by those who camp carrying a back pack as well as those who use one of the many popular recreational vehicles. In both of the above instances, the barbecue must occupy a minimal amount of space while being easily set up and stored.

### SUMMARY OF THE. INVENTION

It is an object of the present invention to provide a portable heating device which may function as a barbecue and which is versatile and occupies a minimum of space for storage purposes.

According to one aspect of the present invention, there is provided a barbecue kit comprising a bowl having a base, end and side walls, the base having a central planar portion and a plurality of downwardly sloping portions between the planar central portion and the walls, a plurality of apertures in the base, a support assembly, the support assembly including a plurality of hollow support arms, each support arm fitting within one of the apertures in the base, a manifold connected to the hollow support arms, and a fan associated with the manifold to blow air through the hollow support arms to the interior of the base.

The barbecue kit, set forth above, includes the bowl which is characterized by having a planar central portion and then downwardly extending or sloping portions between the planar portion and the walls defining the bowl. There are provided apertures for receiving a support assembly. In the preferred arrangement, the apertures are located at the corners of the bowl and each one is provided with a collar surrounding the aperture to prevent grease or other extraneous matter from entering the apertures. The support assembly also functions to provide combustion air to the interior of the bowl. To this end, the support assembly will include a manifold which is connected to a driven source of air. The driven source of air may be a control assembly containing a fan which will blow combustion air through a hose which is connected to the manifold. The control assembly is thus located remotely from the barbecue so as to minimize any possible damage to the control assembly. The control assembly will preferably include controls to operate the fan including fan speed and a timer. The timer could be operated such that the fan will blow for a preset period of time after starting the fire. The control panel could either be operated on normally available electricity or battery operated.

The barbecue kit will include a grill preferably with a handle which is used to lift and lower the grill.

The barbecue kit will also include a cover. The cover can be utilized when the barbecue is used for heating purposes. Conveniently, the cover may include a mesh filter so as to prevent any sparks from escaping.

As an alternative to using conventional barbecue fuels, the barbecue of the present invention may also be adapted for use by propane. In this embodiment, a propane burner is supported at a level below the grill and would operate in a conventional fashion. In order to ensure proper safety, the propane burner is supported on legs which fit within the apertures in the bottom of the bowl. This will prevent any air being blown into the bowl during operation in the propane mode.

### BRIEF DESCRIPTION OF THE DRAWINGS

Having thus generally described the invention, reference will be made to the accompanying drawings illustrating an embodiment thereof, in which:

FIG. 1 is a side elevational view, partially in cutaway, of a barbecue kit according to the present invention;

FIG. 2 is a view similar to FIG. 1 illustrating the cover mounted on the bowl;

FIG. 3 is a side elevational view, partially in cutaway, illustrating the bowl being mounted on a support assembly;

FIG. 4 is a perspective view illustrating the grill and bowl;

FIG. 5 is a side elevational view, partially in cutaway, of an embodiment wherein a propane assembly is utilized;

FIG. 6 is a perspective view of a manifold and arms for feeding air to the bowl;

FIG. 7 is an enlarged view illustrating the securement of the cover and base together; and

FIG. 8 is a side elevational view of a handle for lifting the grate.

### DETAILED DESCRIPTION OF THE INVENTION

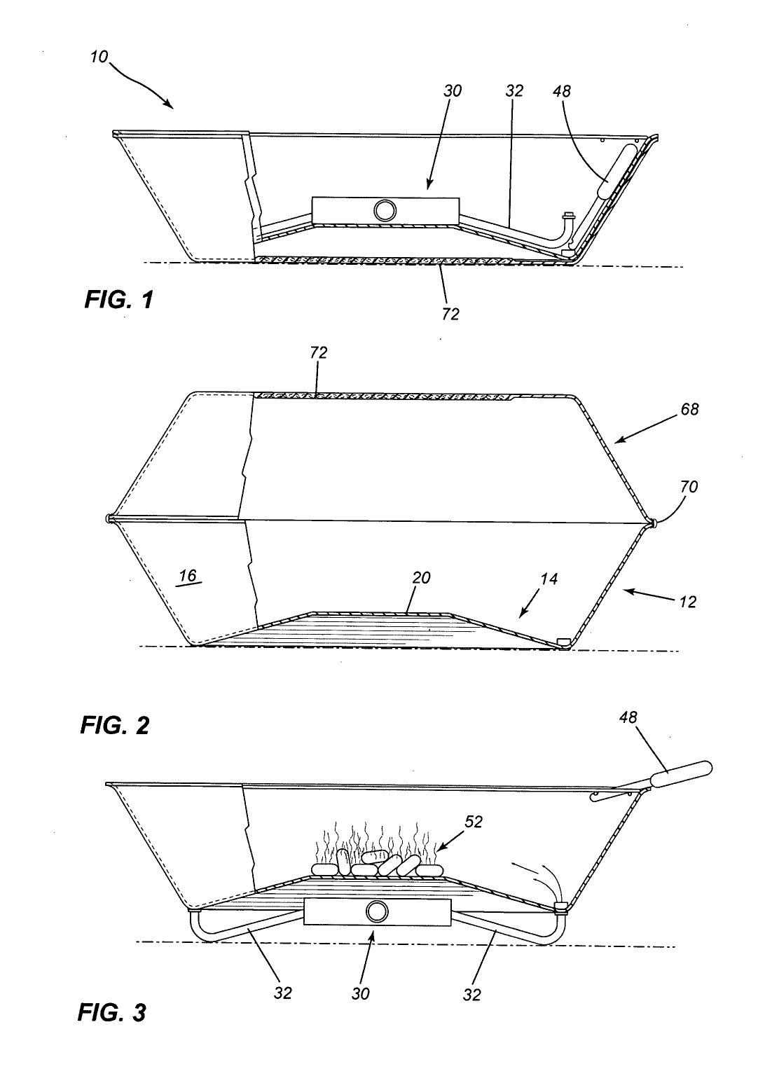

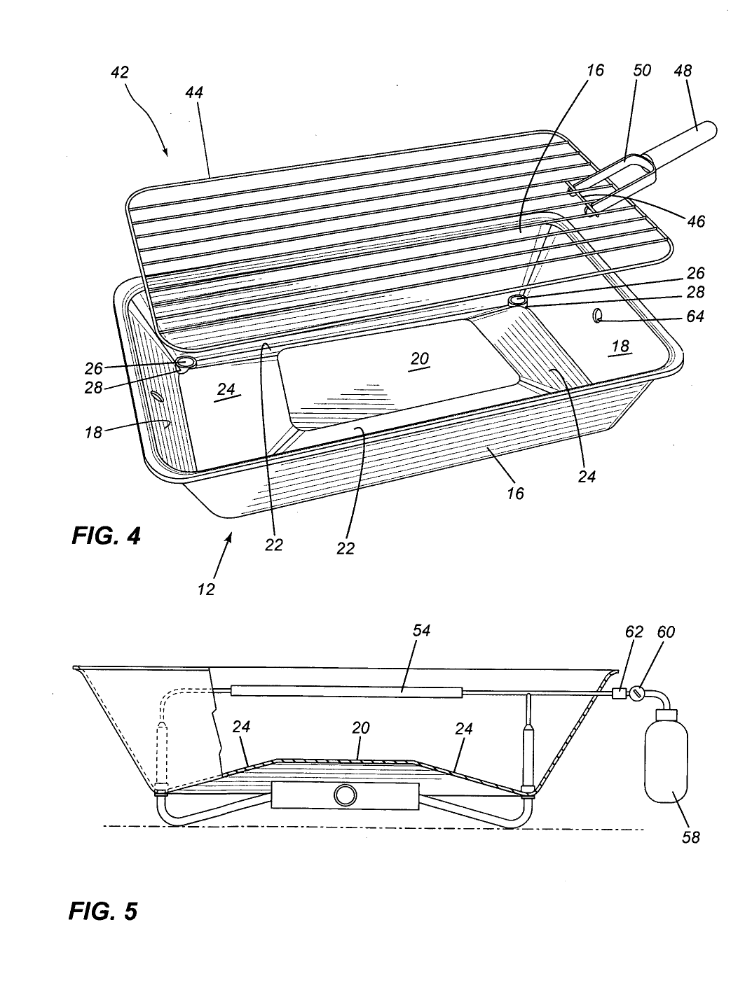

Referring to the drawings in greater detail and by reference characters thereto, there is illustrated in FIG. 1 a barbecue kit generally designated by reference numeral 10.

Barbecue kit 10 includes a bowl generally designated by reference numeral 12 and which bowl 12 has a base 14 along with side walls 16 and end walls 18. Base 14 has a planar central portion 20 and side downwardly sloping portions 22 along with end downwardly sloping portions 24. Downwardly sloping portions 22, 24 extend from the planar central portion 20 to respective side walls 16 and end walls 18.

Located at the four corners of the bowl 12 are apertures 26. Apertures 26 extend through base 14 and each aperture has a collar 28 such that collar 28 rises above the base 14. This arrangement will ensure that grease or fat will not escape through apertures 26.

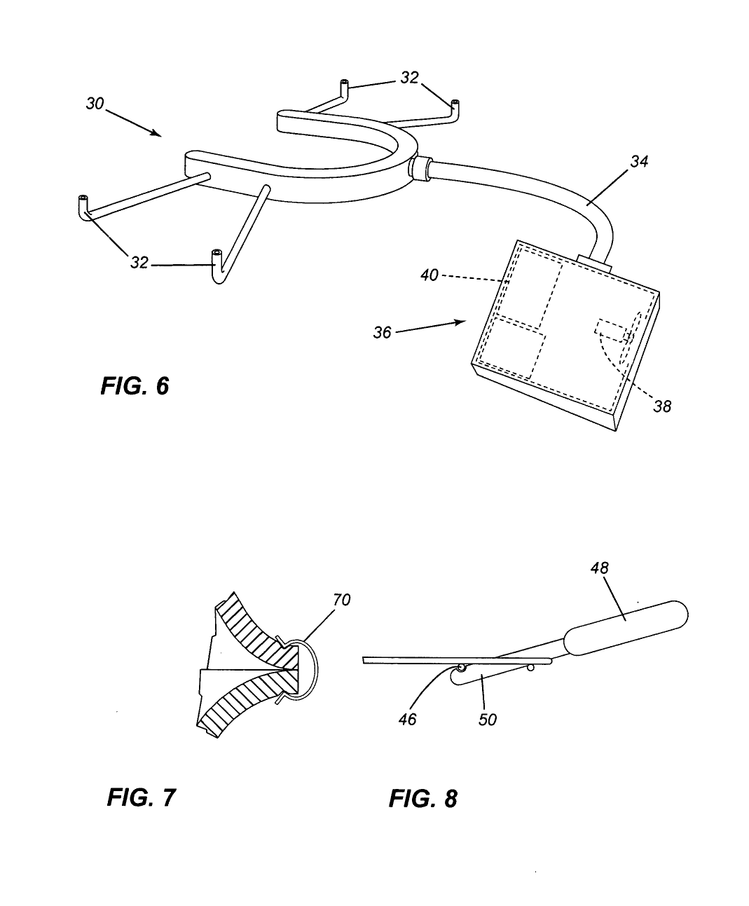

As shown in FIG. 6, there is provided a U-shaped manifold 30 with hollow arms 32 extending therefrom. Arms 32 are designed to fit within respective apertures 26 and provide a support for bowl 12. U-shaped manifold 30 is connected by a flexible hose 34 to a control assembly generally designated by reference numeral 36. Control assembly 36 includes a fan 38 and timer controls 40. Timer controls 40 are designed to turn fan 38 on and off and as well, allow the fan to be preset for a certain period of time.

A grill 42 is of a conventional structure and has a grid 44. As part of grid 44, there is a perpendicular bar 46. A handle 48 has arms 50 extending therefrom, arms 50 being designed to engage perpendicular bar 46 to permit lifting of grill 42.

In use, fuel 52 is placed on central planar portion 20 and ignited. Air flowing through manifold 30 to hollow arms 32 allows a gentle supply of air to be delivered to fuel 52 for efficient combustion. Fan 38 would generally be operable in this mode. When used for cooking purposes, grill 42 is placed on top of bowl 12 and the food is cooked in a conventional barbecue fashion.

The barbecue can also be used in conjunction with a propane tank 58. In this embodiment, a propane burner 54 is placed under grill 42. Propane burner 54 is supported by legs 56 which seat within apertures 26. In this arrangement, support legs 56 block the openings in base 14 such that air cannot be supplied to the interior. Propane burner 54 is connected to propane tank 58 by a valve 60 and pressure regulator 62 as is well known in the art. It will be noted that apertures 64 are provided in end walls 18 to permit passage of the propane line.

The barbecue kit 10 also includes a cover 68 which is designed to seat on top of bowl 12. When desired, clips 70 may be utilized to retain cover 68 in position. Cover 68 preferably includes a filter mesh 72 to prevent any sparks from flying out of the barbecue. This mode may be used to emulate a fireplace or camp fire.

The propane burner utilized may be a standard burner which is mounted to and centered in a custom frame. Near the burner, but outside of the housing, there is preferably a quick connect which will disconnect the burner from the hose that runs to the regulator. The regulator and valve may both be used to shut off the propane supplied to the burner.

The bowl and cover are preferably formed of a suitable stainless steel. The fan, as previously mentioned, may be designed to take household electrical AC current or alternatively utilize a DC battery. Preferably, the AC current may be used to charge a six volt rechargeable battery.

The system is designed to be compact so that it can easily be stored. When stored, the various components will fit together—i.e. the bowl can fit within the cover and the remaining components will fit within the cavity of the cover.

It will be understood that the above described embodiments are for purposes of illustration only and that changes and modifications may be made thereto without departing from the spirit and scope of the invention.

I claim:

1. A barbecue kit comprising:
a bowl having a base, end and side walls, said base having a central planar portion and a plurality of downwardly sloping portions between said planar central portion and said walls;
a plurality of apertures in said base;
a support assembly, said support assembly including a plurality of hollow support arms, each support arm fitting within one of said apertures in said base;
a manifold connected to said hollow support arms, and a fan associated with said manifold to blow air through said hollow support arms to the interior of said base.

2. The barbecue kit of claim 1 wherein each of said apertures is located at a bottom corner of said bowl.

3. The barbecue kit of claim 2 further including a collar surrounding each of said apertures to prevent grease from reaching the apertures.

4. The barbecue kit of claim 1 wherein said kit includes a control assembly, said control assembly having a fan speed control and a timer for said fan.

5. The barbecue kit of claim 1 further including a grill for seating on top of said bowl.

6. The barbecue kit of claim 5 further including a propane burner, said propane burner being supported by legs fitting within each of said apertures in said base to prevent air flowing through said support arms.

7. The barbecue kit of claim 1 further including a cover, said cover fitting over said base.

8. The barbecue kit of claim 7 wherein said cover includes a filter to prevent sparks from escaping therefrom.

9. The barbecue kit of claim 6 further including a flexible hose connected to said propane burner.

10. The barbecue kit of claim 9 further including a handle to lift said grill.
